(19) United States
(12) Patent Application Publication
(10) Pub. No.: US 2004/0266011 A1
(43) Pub. Date: Dec. 30, 2004

(54) In-situ analysis method for atomic layer deposition process

(75) Inventors: Jae-cheol Lee, Gyeonggi-do (KR); Chang-bin Lim, Seoul (KR); Ran-ju Jung, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/874,565

(22) Filed: Jun. 24, 2004

(30) Foreign Application Priority Data
Jun. 26, 2003 (KR) 10-2003-0042128

(51) Int. Cl. G01N 31/00

(52) U.S. Cl. 436/5

(57) ABSTRACT

Provided is an in-situ analysis method for an atomic layer deposition (ALD) process. The provided method includes transferring a substrate to a reaction chamber in a vacuum container, depositing an atomic layer on the upper surface of the substrate, and analyzing the state of the atomic layer to determine the quality of the atomic layer in real time. Using the method decreases failure and the cost for additional analysis.

### BACKGROUND OF THE INVENTION

This application claims the priority of Korean Patent Application No. 200342128, filed on Jun. 26, 2003, in the Korean Intellectual Property Office, the disclosure of which is incorporated herein in its entirety by reference.

1. Field of the Invention

The present invention relates to an in-situ analysis method for an atomic layer deposition (ALD) process.

2. Description of the Related Art

ALD of a layer by sequentially injecting and removing a reactant is a method of growing layer, which is necessary in manufacturing a semiconductor.

FIG. 1 is a flowchart illustrating an ALD method disclosed in U.S. Pat. No. 6,420,279. Referring to FIG. 1, a semiconductor substrate is inserted in a chamber for ALD, in operation 110, and then an atomic layer is deposited by introducing Hf(NO₃)₄ or Zr(NO₃)₄ into the ALD chamber, in operation 120. After the atomic layer is deposited, nitrogen or an inert gas is injected onto the upper surface of the atomic layer to flush the ALD chamber, in operation 130. Hydrogen gas is introduced to the ALD chamber, in operation 140, and the ALD chamber is flushed using nitrogen or an inert gas, in operation 145. Whether additional layers are to be deposited is determined, in operation 150, and annealing is performed to control the atomic layer and interfaces, in operation 160.

When a conventional method of depositing an atomic layer and an apparatus adverting the same are used, the information about the growing speed, thickness, density, and byproducts of the deposited layer cannot be obtained in real time. Such information is obtained by using additional measuring equipment, for example, a transmission electron microscope (TEM), a scanning electron microscope (SEM), or an ellipsometer, after the deposition of the layer is completed. In addition, in order to obtain the information ragarding the composition or the chemical binding state of the elements of the atomic layer, an additional X-ray photoelectron spectroscope (XPS) should be used. Furthermore, while exposing a specimen to an external environment to analyze the specimen, the specimen may be contaminated by various gases such as oxygen, nitrogen, and carbon included in the air, resulting in the deterioration of the analysis.

### SUMMARY OF THE INVENTION

The present invention provides an in-situ analysis method for an atomic layer deposition process.

According to an aspect of the present invention, there is provided an in-situ method for an atomic layer deposition (ALD) process, comprising transferring a substrate to a reaction chamber in a vacuum container and depositing an atomic layer on the upper surface of the substrate, and analyzing the state of the atomic layer to determine the quality of the atomic layer in real time.

The transferring of the substrate to the reaction chamber in the vacuum container and the depositing of the atomic layer on the upper surface of the substrate includes (a) transferring the substrate to the reaction chamber in the vacuum container (b) injecting a source gas into the vacuum container to deposit the atomic layer on the substrate and injecting a transfer gas to exhaust the source gas (c) injecting a reactant gas to react with the atomic layer when the exhaustion of the source gas is completed, and injecting the transfer gas to exhaust a reactant material, and (d) repeating (a) through (c) until the thickness of the atomic layer becomes a predetermined thickness.

The transfer gas may be an inert gas including nitrogen or argon gas, and the reactant gas may be an oxide gas including oxygen, isopropyl alcohol or 03.

The state of the atomic layer may be selectively analyzed from before to after the deposition of the atomic layer.

A residual gas before the ALD or a by-product in depositing the atomic layer may be analyzed by using a quadrupole mass spectrometer. Here, the quadrupole mass spectrometer may be connected to the reaction chamber of the vacuum container through a fine pipe on which a gasket for preventing the gas from being exhausted is installed.

The thickness and the density of the atomic layer may be selectively measured during or after the ALD by using an ellipsometer, and the chemical state of the atomic layer may be selectively analyzed during or after the ALD by using an X-ray photoelectron spectroscopy (XPS).

The vacuum container may include a substrate holder on which the substrate is mounted, and the substrate holder may have a thermal expansion coefficient different from the thermal expansion coefficient of the reaction chamber.

### BRIEF DESCRIPTION OF THE DRAWINGS

The above and other features and advantages of the present invention will become more apparent by describing in a detail exemplary embodiment thereof with reference to the attached drawings in which:

FIG. 1 is a flowchart illustrating a conventional atomic layer deposition (ALD) process;

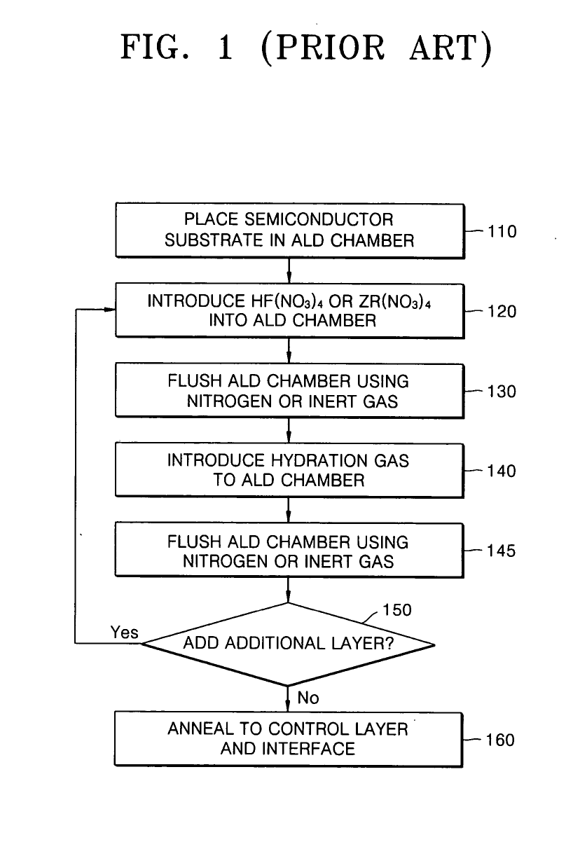

FIG. 2 is a flowchart illustrating an in-situ analysis method for an atomic layer deposition process according to an embodiment of the present invention;

FIG. 3 is a sectional view of an atomic layer deposition analyzer performing the analysis method of FIG. 2;

FIG. 4 is a graph illustrating the strength of Si2p with respect to binding energy after repeating the injection and exhaustion of a source gas and injection and exhaustion of a reactant gas for various numbers times and using an X-ray photoelectron spectroscopy according to the embodiment of the present invention; and

FIG. 5 is a graph illustrating the changes in the peaks of Hf4f by repeating the injection and exhaustion of a source gas and the injection and exhaustion of a reactant gas for 40 times and by using an X-ray photoelectron spectroscopy according to the embodiment of the present invention.

### DETAILED DESCRIPTION OF THE INVENTION

An in-situ analysis method for an atomic layer deposition (ALD) process according to an embodiment of the present invention will now be described more fully with reference to the accompanying drawings, in which an exemplary embodiment of the invention is shown.

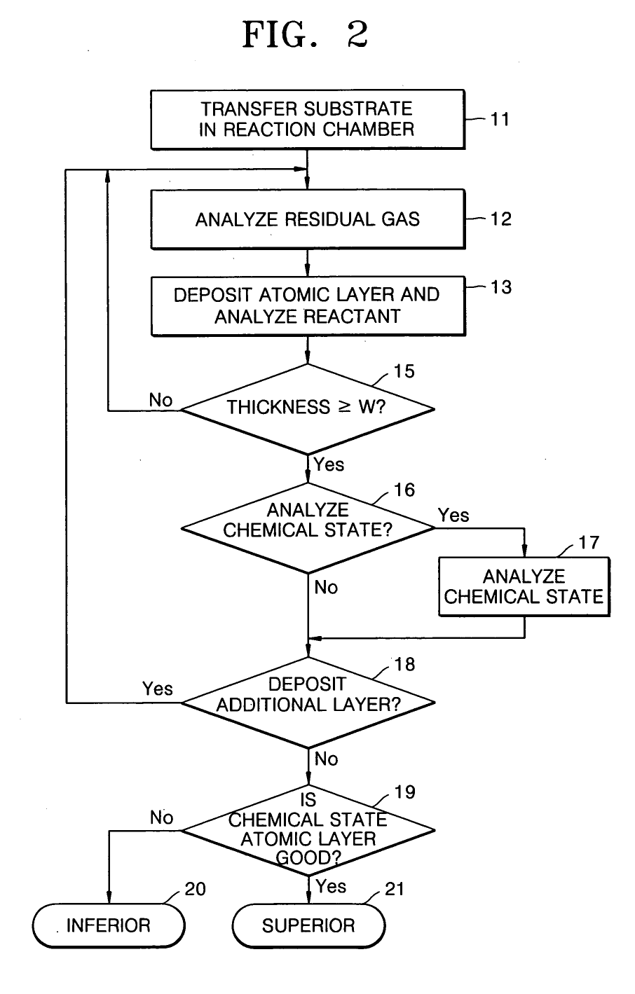

FIG. 2 is a flowchart illustrating an in-situ analysis method for an ALD process according to an embodiment of the present invention.

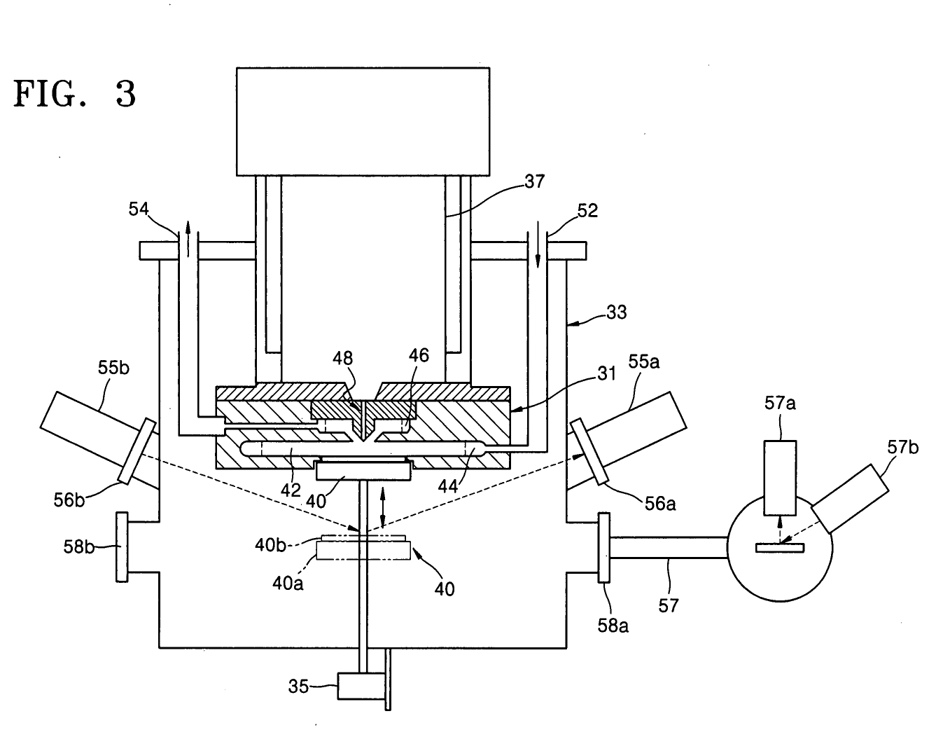

First, a substrate is transferred to a reaction chamber in a vacuum container, in operation 11. The reaction chamber in which an ALD process is performed and a quadrupole mass spectrometer are installed in the vacuum container, and an ellipsometer and an X-ray photoelectron spectroscope (XPS) are connected to ports of the vacuum container. An ALD reactor including a vacuum container will be described with reference to FIG. 3.

Referring to FIG. 3, a vacuum container 33 includes a reactor 31 for performing an ALD process, a gas inlet 52 for injecting gas in to the reactor 31, and a gas outlet 54 for exhausting a gas generated by a reaction from the reactor 31. The vacuum container 33 further includes a specimen path 57 for transferring a specimen 40, first and second specimen ports 58a, and 58b connected to the specimen path 57 for transfer ring the specimen to an XPS 57a disposed outside of the vacuum container 33, and first and second ports 56a and 56b on which an ellipsometer 55a and a light source 55b are mounted. Here, the specimen 40 includes a substrate 40b, which is disposed on the upper surface of a holder 40a, on which an atomic layer is deposited. When the atomic layer is deposited, the specimen 40 further includes the atomic layer (not shown) deposited on the upper surface of the substrate 40b.

The reactor 31 and a quadrupole mass spectrometer 37 are located inside the vacuum container 33 and analyzers, for example, the ellipsometer 55a and the XPS 57a, are located outside the various container in order to perform the deposition and the analysis of the atomic layer. In other words, gases generated when depositing the atomic layer are analyzed so that the state of reaction is analyzed in real time and the deposition and the analysis are performed using a single device.

The reactor 31 includes a reaction chamber 42, a first gas distributor 44, and a second gas distributor 46. Here, the ALD takes place on the specimen 40 in the reaction chamber 42 using a source gas and a reactant gas. The first gas distributor 44 evenly supplies the reactant gas to the reaction chamber 42. The second gas distributor 46 exhausts the reactant gas, after the ALD is performed on the specimen 40 using the source gas and the reactant gas in the reaction chamber 42, in order to maintain the reactant gas in a uniform state in the reaction chamber 42.

A specimen location controller 35 transfers the specimen 40 to a specific location in the reaction chamber 42 for depositing an atomic layer or to a point where the central axes of the first and second ports 56a and 56b meet for measuring the thickness and the density of the atomic layer. The holder 40a on which the substrate 40b is mounted is composed of a material having a higher thermal expansion coefficient than the reactor 31. Accordingly, when the temperature of the reactor 31 is increased to 150 to 350° C., the volume of the holder 40a increases faster than the reaction chamber 42, thus prevention of the exhausting the reactant gas from the reaction chamber 42 to the outside.

A quadrupole mass spectrometer 37, that is, a residual gas analyser, is disposed in the vacuum container 33 and connected to the reaction chamber 42 via a fine pipe 48 and detects and analyzes the gases generated as a by-product while depositing the atomic layer and exhausted from the specimen 40. The by-product generated in the reaction chamber 42 moves from the reactor 31 having a high pressure to the quadrupole mass spectrometer 37 having a low pressure. The amount of gas is determined according to the length and the diameter of the fine pipe 48 and the pumping speed of a pump. A gasket composed of silver may be interposed between the quadrupole mass spectrometer 37 and the fine pipe 48 to prevent the drain age of gases.

The quadrupole mass spectrometer 37 measures the molecular weight of each ion that enters. In the quadrupole mass spectrometer 37, ions in a gas ions phase are classified according to a ratio of mass to charge, the classified ions are collected by a detector, the ions are transformed to electric signals in proportion to the number of ions, and a data system detects the electric signals and converts them into a mass spectrum.

When a polarized beam radiated from the light source 55b is reflected by the specimen 40, the ellipsometer 55a mounted on the first port 56a receives the reflected beam to detect information on the specimen 40.

The XPS 57a analyzes the energy of photoelectrons emitted from the surface of the specimen 40 when X-rays with a specific wavelength are emitted by the light source 57b to determine the composition and the chemical binding state of the atomic layer.

The source gas and the reactant gas are injected to the reaction chamber 42 via the gas inlet 52 and uniformly supplied to the reaction chamber 42 by the first gas distributor 44. The source gas and the reactant gas react with the specimen 40 to deposit an atomic layer on a surface of the specimen 40. The residual gas remaining after the reaction is collected in the central portion of the specimen 40 and discharged through the reactant gas outlet 54 via the second gas distributor 46. The gases generated when depositing the atomic layer and removed from the specimen 40 are exhausted to the quadrupole mass spectrometer 37 from the reaction chamber 42 through the fine pipe 48.

The gases in the vacuum container 33 are transferred from the reaction chamber 42 having a high pressure to the quadrupole mass spectrometer 37 having a low pressure through the fine pipe 48. Here, the amount of the gases is determined by the length and the diameter of the fine pipe 48 and the pumping speed of the pump, which maintains the vacuum container 33 in a vacuum state.

Referring back to FIG. 2, the residual gas in the reaction chamber 42 is analyzed using the quadrupole mass spectrometer 37, in operation 12, before depositing an atomic layer, to examine the effects of the residual gas on a surface of the specimen 40. The analysis process before the deposition of the atomic layer can be alternatively performed.

After the residual gas in the reaction chamber 42 is analyzed, the pressure of the vacuum container 33 is maintained at less than 10⁻⁸ torr to deposit the atomic layer, and the source gas is injected to the reactor 31 for a predetermined amount of time, generally, less than one second to several seconds. While depositing the atomic layer, the by-product is continuously analyzed using the quadrupole mass spectrometer 37, in operation 13.

After the atomic layer is deposited by using the source gas, a transfer gas composed of a gas ions element, such as nitrogen or argon, is injected to sufficiently exhaust the source gas. When the source gas is completely exhausted, the reactant gas including oxygen, for example, water, isopropyl alcohol or O₃, is injected to oxidize the deposited material. The reactant gas reacts with the atomic layer, thereby converting the atomic layer into a predetermined material. After a predetermined amount of time, the supply of the reactant gas is stopped and the transfer gas is injected again to exhaust the reactant gas. The atomic layer is formed on the substrate by injecting the source gas, exhausting the source gas, the injection of the reactant gas, and the exhausting the reactant gas. In the present embodiment, the flows of the source gas and the reactant gas largely affect the uniformity of the atomic layer. In order to examine the reaction characteristics of the source gas while depositing the atomic layer, the reaction by-product is analyzed using the quadrupole mass spectrometer 37.

The ellipsometer 55a measures whether the thickness and the density of the atomic layer are equal to or greater than a predetermined thickness W and density while depositing the atomic layer, in operation 15. When the thickness and the density of the atomic layer are greater than the predetermined thickness W and density, it is determined to whether analyze the chemical state of the atomic layer, in operation 16.

When the chemical state of the atomic layer is to be analyzed, the specimen 40 on which the atomic layer is deposited is transferred to the XPS 57a and the chemical state of the atomic layer is analyzed, in operation 17. Here, the chemical state of the atomic layer refers to the chemical composition and the chemical binding state of the atomic layer.

When the analysis of the chemical state is determined to be not performed or the analysis of the chemical state is completed using the XPS 57a, it is determined whether an additional atomic layer should be deposited, in operation 18. When the additional atomic layer should be deposited, the process returns to operation 12. Otherwise, the ALD process is completed and the chemical state of the final atomic layer is analyzed using the XPS 57a, in operation 19.

The quadrupole mass spectrometer 37 may analyze the state of the atomic layer before, during, and after the deposition of the atomic layer in real time, and the ellipsometer 55a and the XPS 57a may analyze the chemical state of the atomic layer during and after the deposition of the atomic layer. When the result of the chemical analysis of the atomic layer does not comply with predetermined standards, the atomic layer is determined to be an inferior layer and is disposed of, in operation 20. When the result of the chemical analysis of the atomic layer does comply with predetermined standards, the atomic layer is determined to be a superior layer, in operation 21.

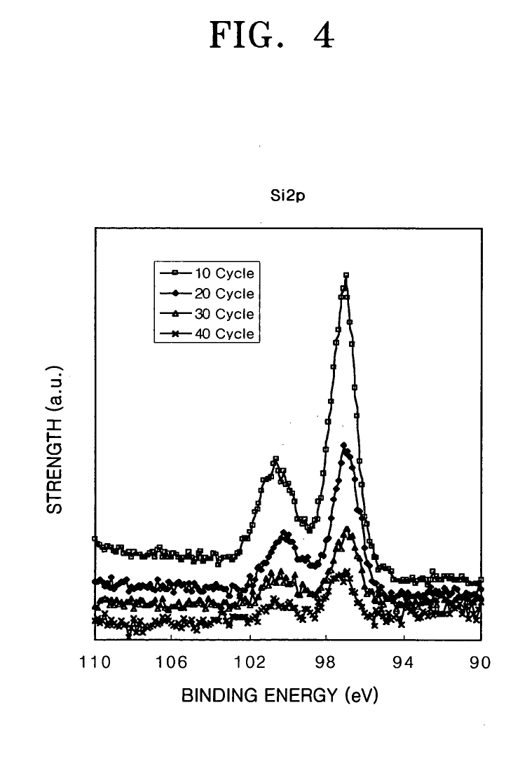

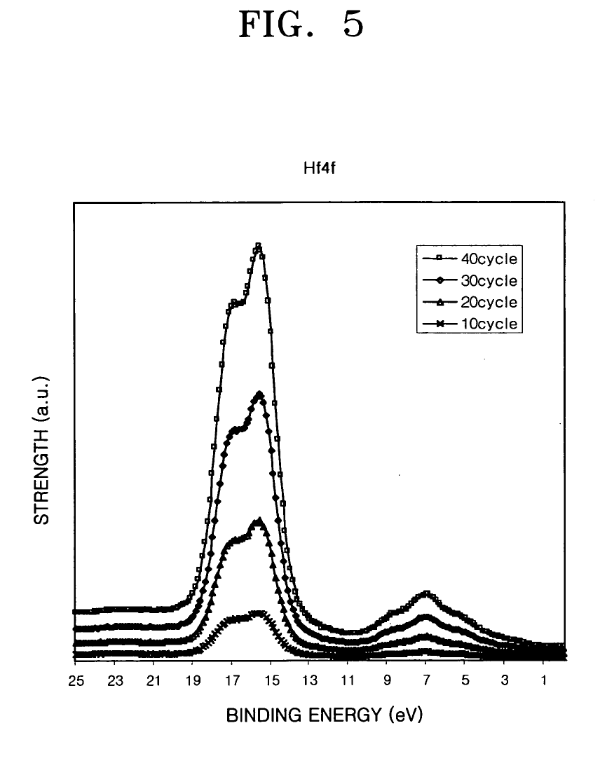

FIG. 4 is a graph illustrating the strength of Si2p, which is generated by the silicon substrate with respect binding energy after repeating the injection and exhaustion of the source gas and the injection and exhaustion of the reactant gas for various numbers of times and using the XPS according to an embodiment of the present invention, and FIG. 5 is a graph illustrating the strength of Hf4f with respect to binding energy under the same conditions.

Referring to FIG. 4, as the number of ALD processes increases from 10 to 40, the strength peak of the Si₂p binding energy, at 98.5 eV gradually decreases. Accordingly, it is determined that the thickness of the atomic layer deposited on the silicon substrate increases as the number of ALD processes increases.

Referring to FIG. 5, as the number of the ALD processes increases from 10 to 40 times, the strength peak of the Hf4f binding energy at 16 eV gradually increases. When HfCl₄ is used as the source gas and H₂O is used as the reactant gas, HfO₂ and HCl are generated. Here, the Hf4f is a result of Hf of HfO₂ deposited on the substrate. As the number of ALD processes increases, the amount of Hf in HfO₂ deposited on the substrate increases.

As described above, the in-situ analysis method for the ALD process can be used to measure the thickness and the density of an atomic layer while depositing the atomic layer, and analyze the chemical state of the atomic layer and by-products in real time to determine the quality of the atomic layer, resulting in a decrease in failure and in the cost for an additional analysis.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An in-situ analysis method of an atomic layer deposition (ALD) process, the method comprising:
transferring a substrate to a reaction chamber in a vacuum container and depositing an atomic layer on the upper surface of the substrate; and
analyzing the state of the atomic layer to determine the quality of the atomic layer in real time.

2. The method of claim 1, wherein the transferring of the substrate to the reaction chamber in the vacuum container and the depositing of the atomic layer on the upper surface of the substrate includes:
transferring the substrate to the reaction chamber in the vacuum container;
injecting a source gas into the vacuum container to deposit the atomic layer on the substrate and injecting a transfer gas to exhaust the source gas;
injecting a reactant gas to react with the atomic layer when the exhaustion of the source gas is completed, and injecting the transfer gas to exhaust a reactant material; and
repeating the transferring the substrate depositing the atomic layer and oxidizing the atomic layer until the thickness of the atomic layer becomes a predetermined thickness.

3. The method of claim 2, wherein the transfer gas is a neutral gas comprising nitrogen or argon gas.

4. The method of claim 2, wherein the reactant gas is an oxide gas comprising water, isopropyl alcohol or O₃.

5. The method of claim 1, wherein the state of the atomic layer is selectively analyzed before, during and after the deposition of the atomic layer.

6. The method of claim 1, wherein the transfer of the substrate to the reaction chamber in the vacuum container and the deposition of the atomic layer on the upper surface of the substrate includes analyzing a residual gas before the deposition of the atomic layer using a quadrupole mass spectrometer.

7. The method of claim 1, wherein the analyzing of the state of the atomic layer to determine the quality of the atomic layer in real time includes analyzing a by-product when depositing the atomic layer using a quadrupole mass spectrometer.

8. The method of claim 6, wherein the quadrupole mass spectrometer is connected to the reaction chamber of the vacuum container by a fine pipe on which a gasket preventing the gas from being exhausted is installed.

9. The method of claim 7, wherein the quadrupole mass spectrometer is connected to the reaction chamber of the vacuum container by a fine pipe on which a gasket preventing the gas from being exhausted is installed.

10. The method of claim 1, wherein the thickness and the density of the atomic layer are selectively measured during or after the ALD using an ellipsometer.

11. The method of claim 1, wherein the chemical state of the atomic layer is selectively analyzed during or after the ALD using an X-ray photoelectron spectroscope (XPS).

12. The method of claim 1, wherein the vacuum container comprises a substrate holder on which the substrate is mounted.

13. The method of claim 12, wherein the substrate holder has a thermal expansion coefficient different from the thermal expansion coefficient of the reaction chamber.
